(19) United States
(12) Patent Application Publication
(10) Pub. No.: US 2010/0140431 A1
(43) Pub. Date: Jun. 10, 2010

(54) APPARATUS FOR SUPPORTING AN INVERTED CONTAINER

(76) Inventor: Cynthia L. VAN HORNE, Charlotte, NC (US)

Correspondence Address: Clements Bernard PLLC, 1901 Roxborough Road, Suite 250, Charlotte, NC, 28211, US

(21) Appl. No.: 12/631,362

(22) Filed: Dec. 4, 2009

Related U.S. Application Data
(60) Provisional application No. 61/119,840, filed on Dec. 4, 2008.

(51) Int. Cl. F16M 13/00

(52) U.S. Cl. 248/274.1; 248/311.3

(57) ABSTRACT

The present disclosure provides an apparatus for supporting a plurality of different shaped and sized containers in an inverted position for draining the containers. The apparatus can support the different shaped and sized containers through a plurality of retaining structures within the apparatus. Advantageously, the apparatus provides universal support in a single structure for small containers (e.g., cosmetic bottle, etc.) up to large containers (e.g., laundry detergent, shampoo, etc.).

### CROSS-REFERENCE TO RELATED APPLICATION(S)

The present non-provisional patent application/patent claims the benefit of priority of co-pending U.S. Provisional Patent Application No. 61/119,840, filed on Dec. 4, 2008, and entitled “APPARATUS FOR SUPPORTING AN INVERTED CONTAINER,” the contents of which are incorporated in full by reference herein.

### FIELD OF THE INVENTION

The present invention relates generally to a container holder. More particularly, the present invention provides an apparatus for supporting a plurality of different shaped and sized containers in an inverted position for draining the containers.

### BACKGROUND OF THE INVENTION

Various household containers, bottles, and the like are typically disposed of with some remnants of the contents settled in the bottom. Exemplary containers, bottles, and the like include shampoo, dishwashing detergent, laundry detergent, ketchup, salad dressing, cosmetic bottle, and the like. Conventionally, consumers often stand the container, bottle, or the like in an inverted position to drain the contents to the top so that they can be removed. Disadvantageously, conventional containers, bottles, and the like are not designed to stand in the inverted position. Often, consumers have to prop up the container, bottle, or the like.

Conventional mechanisms include containers designed to stand in an inverted position and support apparatuses to hold the containers in an inverted position. Exemplary container support apparatuses are disclosed in U.S. Pat. Nos. 5,950,698, 5,755,418, and 5,105,860. Each of these container support apparatuses is configured to support a substantially cylindrical top portion of the container. Accordingly, each of these container support apparatuses fails to provide support for varying sizes and shapes of containers.

### BRIEF SUMMARY OF THE INVENTION

In various exemplary embodiments, the present invention provides an apparatus for supporting a plurality of different shaped and sized containers in an inverted position for draining the containers. The apparatus can support the different shaped and sized containers through a plurality of retaining structures within the apparatus. Advantageously, the apparatus provides universal support in a single structure for small containers (e.g., cosmetic bottle, etc.) up to large containers (e.g., laundry detergent, shampoo, etc.).

In an exemplary embodiment of the present invention, an apparatus for supporting an inverted container includes a structure with an inner surface and an outer surface; and a plurality of retaining structures disposed to the inner surface and extending out from the inner surface forming a center portion of the structure; wherein the center portion is adapted to receive a top portion of a container and the plurality of retaining structures are adapted to support the container in an inverted position. Each of the plurality of retaining structures is spaced apart from adjacent retaining structures forming an opening. Optionally, the opening is adapted to receive a small container relative to the container and to support the small container in an inverted position. The apparatus for supporting an inverted container can further include a support structure disposed to the outer surface. Optionally, the plurality of retaining structures and the structure include a flexible material. Alternatively, the structure includes a ring shape. The plurality of retaining structures are configured to support a plurality of containers, the plurality of containers including multiple shapes and multiple sizes. The plurality of retaining structures are flexible and adapt to a shape and size of a particular contained of the plurality of containers thereby supporting the particular container in an inverted position. A larger container disposed within the structure contacts substantially all of the plurality of retaining structures and a small container relative to the larger container contacts substantially fewer of the plurality of retaining structures relative to the larger container.

In another exemplary embodiment of the present invention, an insert for a container basket to support containers in an inverted position includes an insert support structure with an inner surface and an outer surface; a plurality of retaining structures disposed to the inner surface and extending out from the inner surface forming a center portion of the structure; wherein the center portion is adapted to receive a top portion of a container and the plurality of retaining structures are adapted to support the container in an inverted position. The plurality of retaining structures are flexible and adapt to a shape and size of a particular contained of the plurality of containers thereby supporting the particular container in an inverted position.

In yet another exemplary embodiment of the present invention, a shower container includes a support structure with an inner surface and an outer surface; a plurality of retaining structures disposed to the inner surface and extending out from the inner surface forming a center portion of the structure; wherein the center portion is adapted to receive a top portion of a container and the plurality of retaining structures are adapted to support the container in an inverted position. The plurality of retaining structures can include a flexible material. The support structure can include a rectangular shape or a triangular shape. The plurality of retaining structures are flexible and adapt to a shape and size of a particular contained of the plurality of containers thereby supporting the particular container in an inverted position.

### BRIEF DESCRIPTION OF THE DRAWINGS

The present invention is illustrated and described herein with reference to the various drawings, in which like reference numbers denote like system components, respectively, and in which:

FIG. 1 illustrates a container holder for supporting a container in an inverted position according to an exemplary embodiment of the present invention;

FIG. 2 illustrates the container holder of FIG. 1 with notches 24 in each of a plurality of retaining structures according to an exemplary embodiment of the present invention;

FIG. 3 illustrates the container holder of FIG. 1 with a support structure on the outer surface of the ring according to an exemplary embodiment of the present invention;

FIGS. 4 and 5 illustrate top views of the container holders in FIGS. 1 and 3 with and without the support structure according to an exemplary embodiment of the present invention;

FIGS. 6-8 illustrate the container holder engaging various containers 30, 32, 34 according to an exemplary embodiment of the present invention;

FIGS. 9 and 10 illustrate a container basket with an inverted storage portion for supporting a container in an inverted position according to an exemplary embodiment of the present invention; and

FIG. 11 illustrates various exemplary embodiments for retaining structures 60, 62, 64 according to the present invention.

### DETAILED DESCRIPTION OF THE INVENTION

In various exemplary embodiments, the present invention provides an apparatus for supporting a plurality of different shaped and sized containers in an inverted position for draining the containers. The apparatus can support the different shaped and sized containers through a plurality of retaining structures within the apparatus. Advantageously, the apparatus provides universal support in a single structure for small containers (e.g., cosmetic bottle, etc.) up to large containers (e.g., laundry detergent, shampoo, etc.).

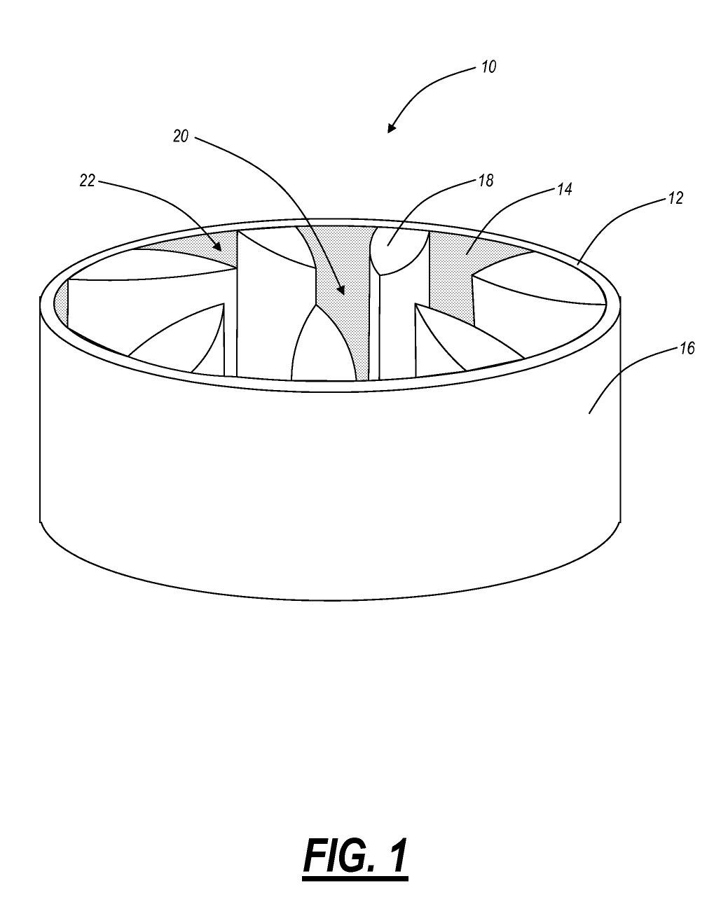

Referring to FIG. 1, a container holder 10 is illustrated for supporting a container in an inverted position according to an exemplary embodiment of the present invention. The container holder 10 includes a ring 12 with an inner surface 14 and an outer surface 16 and a plurality of retaining structures 18 disposed to the inner surface 14. The plurality of retaining structures 18 extend from the inner surface 14 towards a center 20 of the ring 12. Each of the retaining structures 18 is spaced apart from adjacent retaining structures 18 to form an opening 22 between each of the retaining structures 18.

The container holder 10 is utilized to provide support for a container, bottle, or the like in an inverted position. The container holder 10 can support varying shapes and sizes through the same ring 12. For large containers, the container is placed in the center 20 engaging one or more of the retaining structures 18 for support. For small containers, the container can be placed in one of the openings 22 between adjacent retaining structures 18 for support.

The retaining structures 18 can include a flexible material, such as rubber, plastic, cardboard, and the like. Additionally, the ring 12 can include the same flexible material in an integrated mold. Alternatively, the ring 12 can include a rigid material. With either type of material, the ring 12 substantially maintains its shape when a container is engaged within the ring 12. The retaining structures 18 are operable to flexibly grip the container providing support within the ring 12. Specifically, the retaining structures 18 can support a plurality of different containers and the retaining structures 18 adapt to a shape and size of a particular container being supported. For example, a larger container disposed within the ring 12 contacts substantially all of the retaining structures 18 and a small container relative to the larger container contacts substantially fewer of retaining structures 18 relative to the larger container.

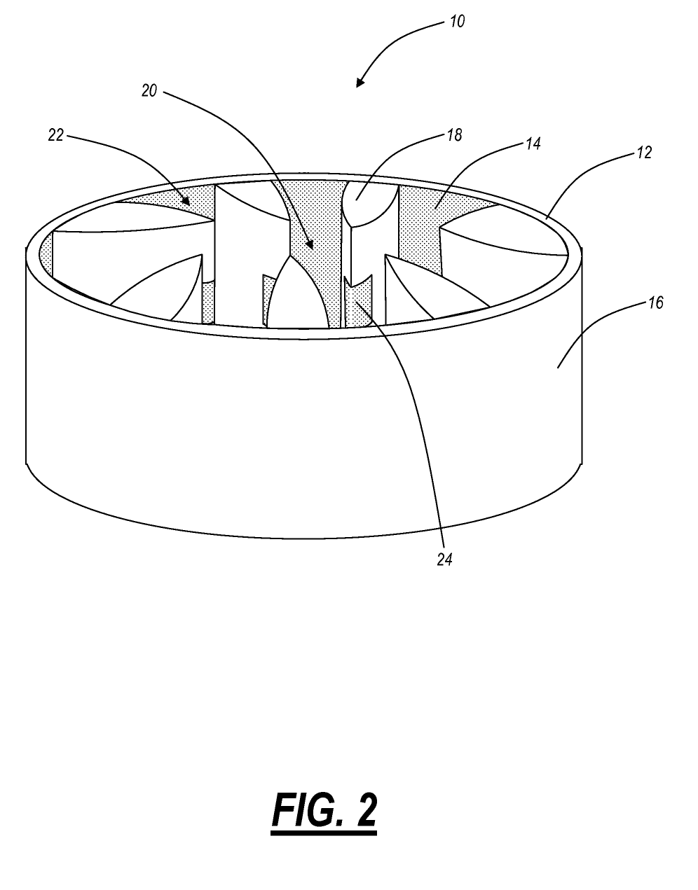

Referring to FIG. 2, the container holder 10 is illustrated with notches 24 in each of the plurality of retaining structures 18 according to an exemplary embodiment of the present invention. The notches 24 are located approximately at a midpoint of the height of the ring 12 in each of the plurality of retaining structures 18. The notches 24 provide an additional gripping mechanism for a container and additional support for smaller containers.

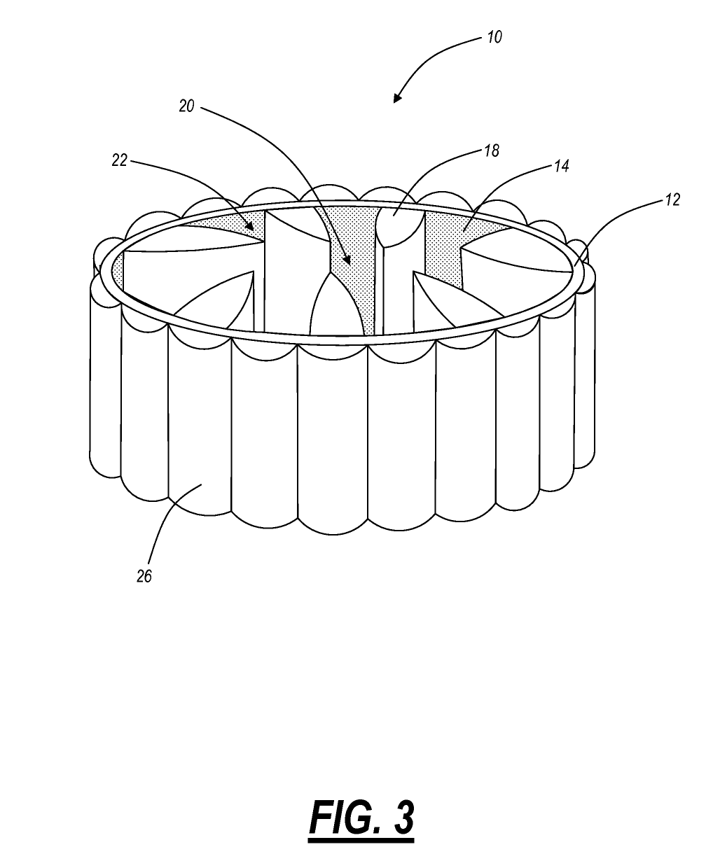

Referring to FIG. 3, the container holder 10 is illustrated with a support structure 26 on the outer surface 16 according to an exemplary embodiment of the present invention. The ring 12 provides force to support a container in the inverted position. If the ring 12 is constructed from a flexible material, the support structure 26 can provide additional support to the outer surface 16 of the ring 12 to assist the ring 12 in keeping its shape to support large containers in an inverted position.

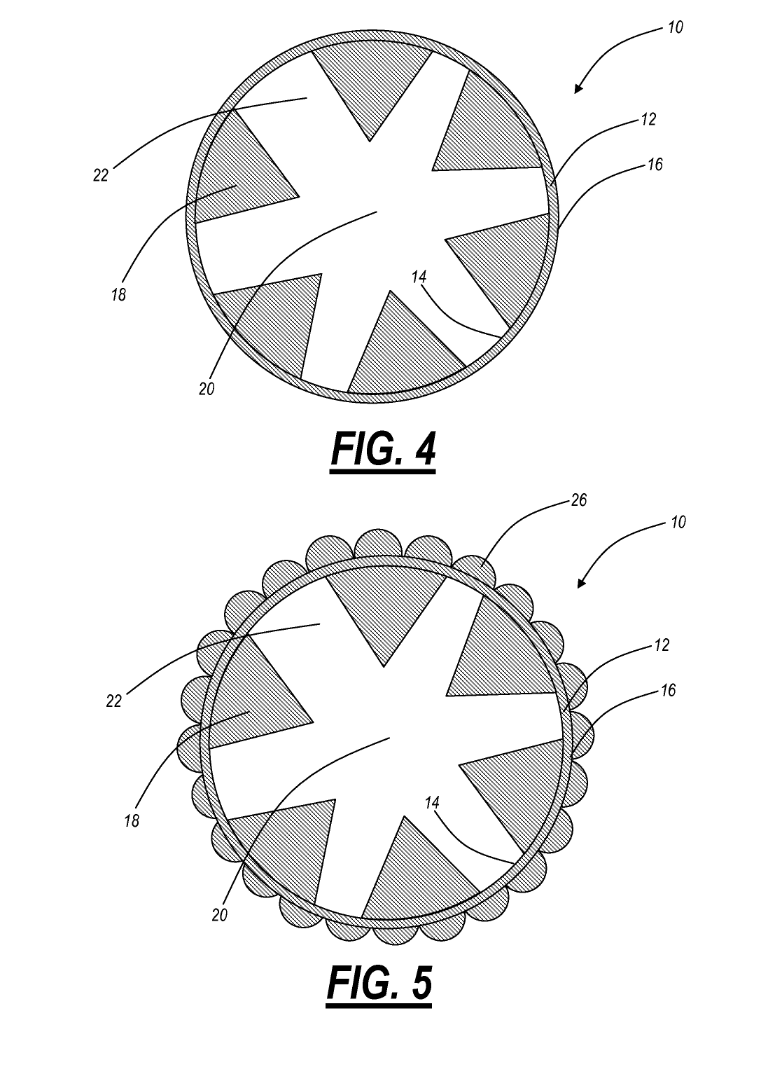

Referring to FIGS. 4 and 5, top views illustrate the container holder 10 with and without the support structure according to an exemplary embodiment of the present invention. For example, the ring 12 can include a diameter of between two inches and five inches. The plurality of retaining structures 18 can protrude out from the inner surface 14 by between one-half inches to two inches covering approximately 15 to 30% of the interior volume of the ring 12. Accordingly, the container holder 10 is dimensioned to support large containers and small containers in a single structure.

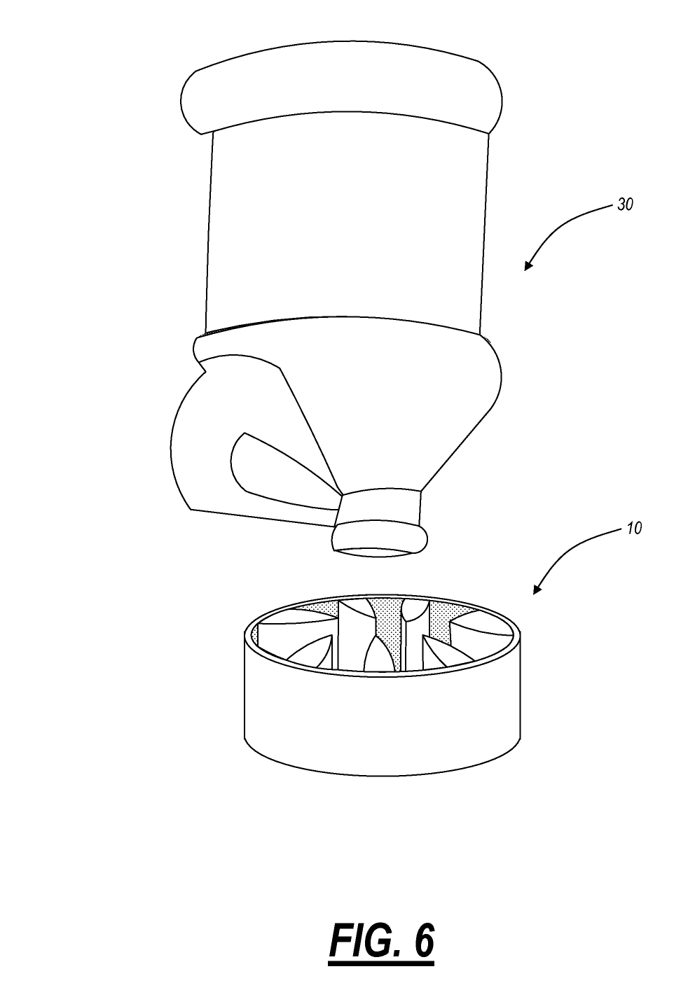

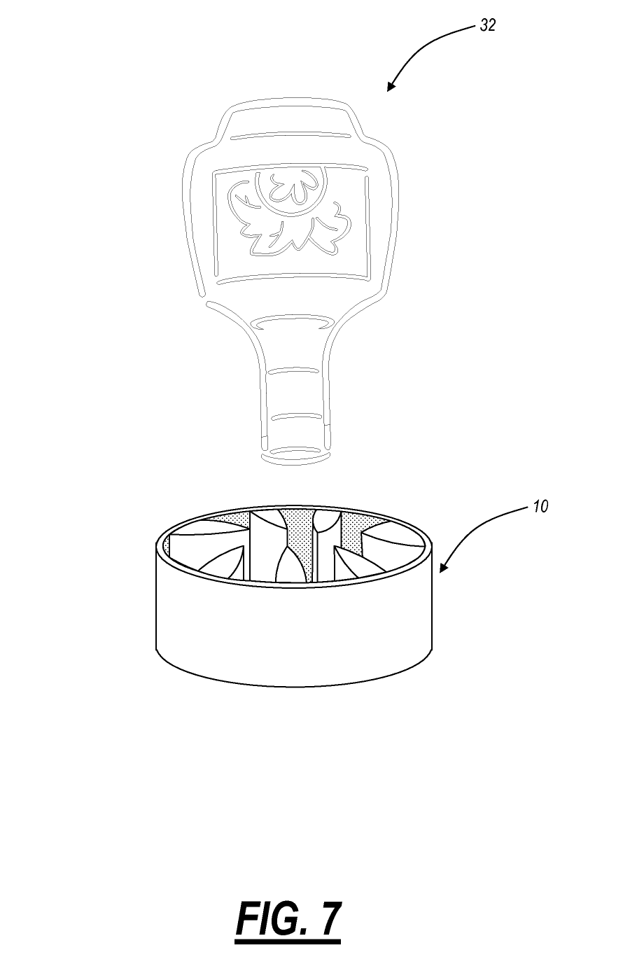

Referring to FIGS. 6-8, the container holder 10 is illustrated engaging various containers 30, 32, 34 according to an exemplary embodiment of the present invention. FIG. 6 illustrates the container holder 10 with a large container 30, such as laundry detergent or the like. Here, the large container 30 is placed at the center 20 engaging the retaining structures 18, i.e. substantially all of the retaining structures. The ring 12 provides support enabling the large container 30 to remain stationary in an inverted position. FIG. 7 illustrates the container holder 10 with a medium sized container 32, such as a salad dressing bottle. Similar to the large container 30, the medium sized container 32 is positioned at the center 20, and is gripped by the retaining structures 18 to provide support.

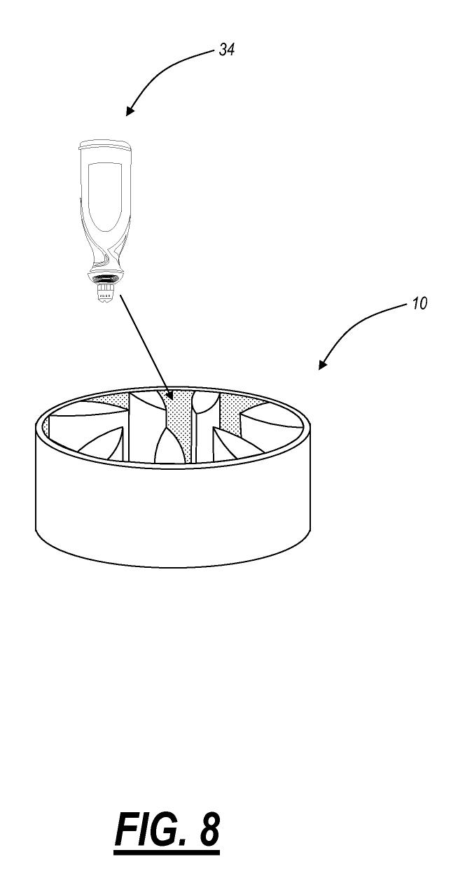

FIG. 8 illustrates the container holder 10 with a small container 34, such as a cosmetics bottle or the like. Here, the small container 34 is positioned in one of the openings 22 between the retaining structures 18. The container holder 10 utilizes the retaining structures 18 to provide support to the small container 34. Here, the small container 34 only contacts a couple of the retaining structures 18, fewer than the large container 30.

In the various exemplary embodiments described herein, the container holder 10 is illustrated with the ring 12 in a circular shape. The present invention contemplates different shapes. For example, the container holder 10 can include a straight surface for positioning in a shower against a wall. Alternatively, the container holder 10 can include an elliptical shape or the like.

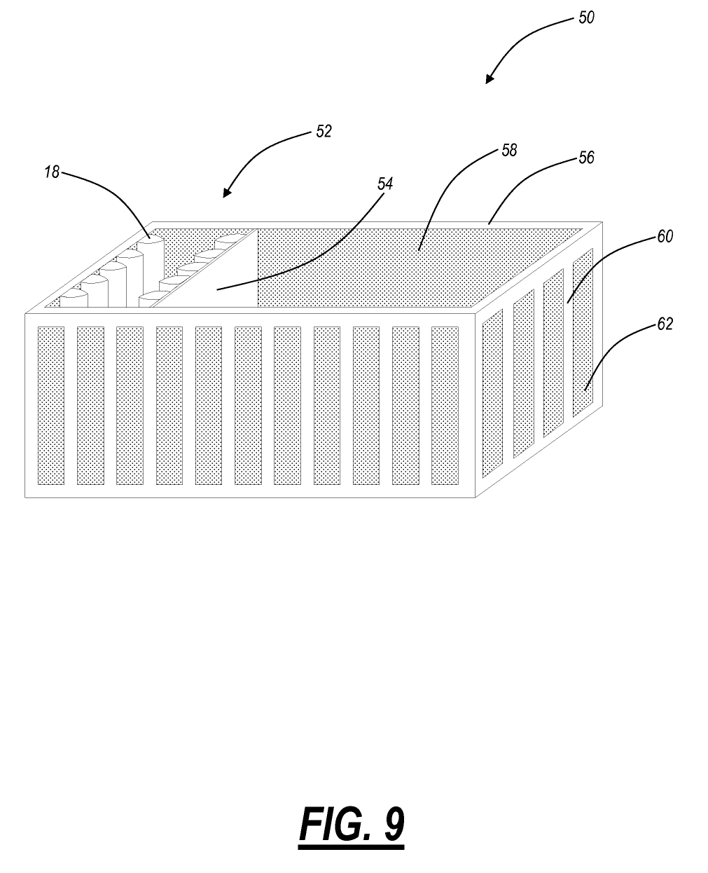

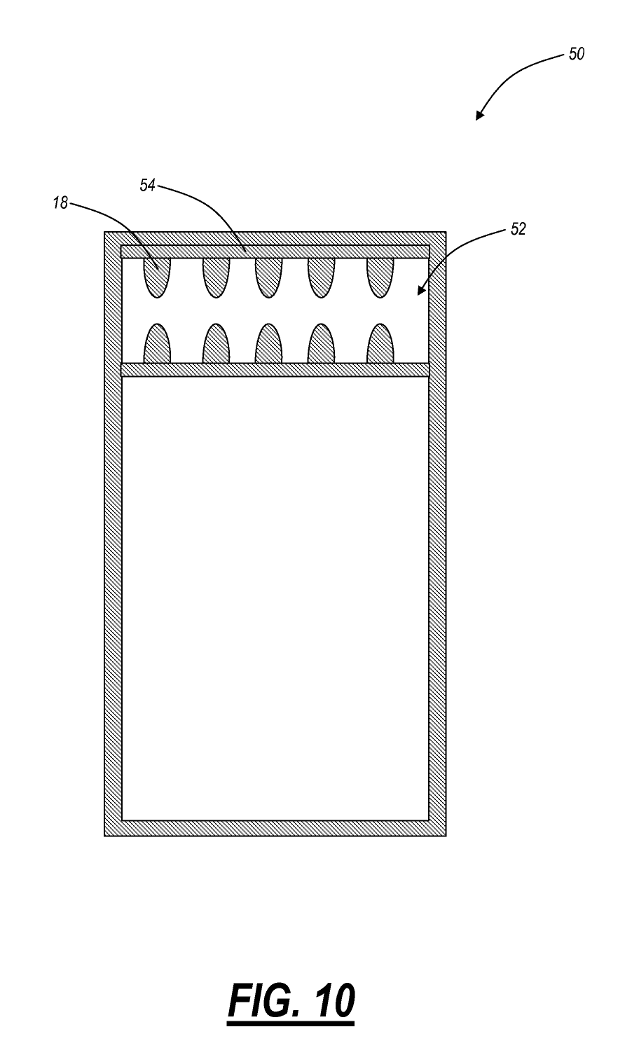

Referring to FIGS. 9 and 10, a container basket 50 is illustrated with an inverted storage portion 52 for supporting a container in an inverted position according to an exemplary embodiment of the present invention. Individuals can use the container basket 50 for storing toiletries and the like in a bathroom, dormitory, etc. The container basket 50 includes the inverted storage portion 52 for inverted storage of shampoo and the like. The inverted storage portion 52 includes a plurality of retaining structures 18 adapted to provide gripping and support of containers in an inverted position.

In an exemplary embodiment, the inverted storage portion 52 includes a separate insert which is adapted to fit within the container basket 50. Here, each of the plurality of retaining structures 18 is disposed to an insert 54 which can be inserted into the container basket 50. Alternatively, the inverted storage portion 52 can be molded as part of the container basket 50.

The container basket 50 includes a support structure 56 with an inner surface 58 and an outer surface 60. In the exemplary embodiment of FIGS. 9 and 10, the container basket 50 includes a rectangular shape. The present invention contemplates alternative shapes, such as triangular and the like. Additionally, the support structure 56 can include openings 62 from the inner surface 58 to the outer surface 60. For example, the openings 62 can allow water to drain through the container basket 50 if the container basket 50 is stored in a shower or the like.

Advantageously, the inverted storage portion 52 enables inverted storage of shampoo and the like to provide easy access to the contents of the container. The container basket 50 can include any type of material, such as plastic, rubber, metal, and the like. Additionally, the container basket 50 can be waterproof for storing in a shower or bathtub. For example, the container basket 50 can include a triangular shape to fit in a shower.

FIG. 10 illustrates a top view of the container basket 50. In an exemplary embodiment, the container basket 50 is four to eight inches high, six to twenty-four inches wide, and six to twelve inches deep. The inverted storage portion 52 takes up a portion of the container basket 50 as most contents in the container basket 50 likely do not need to be support in an inverted position. However, the present invention can also include multiple inverted storage portions 52. Alternatively, the container basket 50 could include the plurality of retaining structures 18 covering the entire volume of the container basket 50.

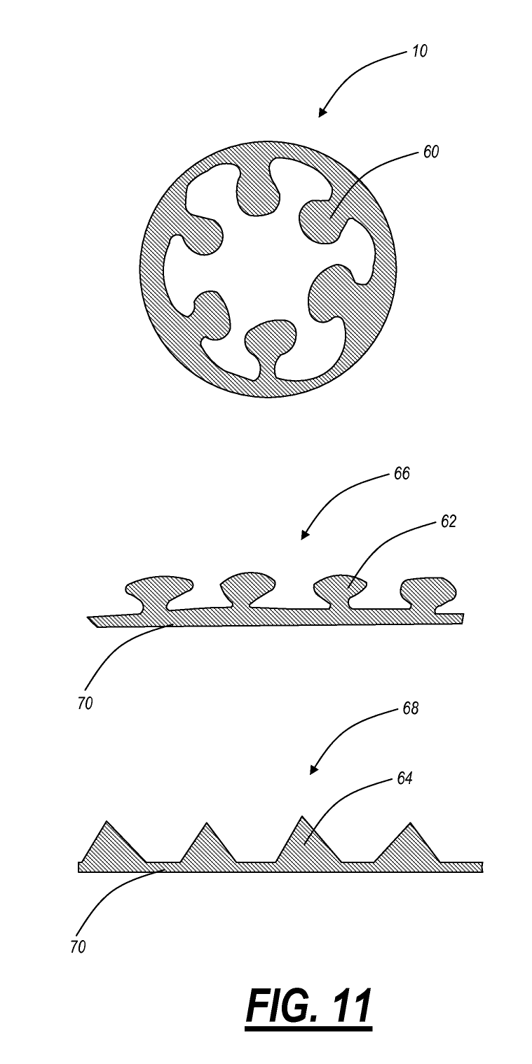

Referring to FIG. 11, various exemplary embodiments are illustrated for retaining structures 60, 62, 64 according to the present invention. The retaining structure 60 is illustrated in the container holder 10, and the retaining structure 60 includes a bulbous shape. The bulbs can retain and provide support to smaller bottles, e.g. cosmetic bottles and the like.

Additionally, the retaining structures 62, 64 can be formed on strips 66, 68. Each of the strips 66, 68 includes a backing 70 which can be fixedly attached to another structure to enable the retaining structures 62, 64 to provide inverted support. The strips 66, 68 could be from a flat stock that is unwrapped and placed into any arbitrary structure with an arbitrary shape or form. The backing 70 can include an adhesive or other mechanism for fixedly or removably attaching the retaining structures 62, 64 to a structure. For example, the strips 66, 68 could be 12″-24″ long by 3-4″ wide. In an exemplary application, the strips 66, 68 could be placed into a door compartment of a refrigerator providing inverted support for containers in the door compartment.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. An apparatus for supporting an inverted container, comprising:
a structure comprising an inner surface and an outer surface; and
a plurality of retaining structures disposed to the inner surface and extending out from the inner surface forming a center portion of the structure;
wherein the center portion is adapted to receive a top portion of a container and the plurality of retaining structures are adapted to support the container in an inverted position.

2. The apparatus for supporting an inverted container of claim 1, wherein each of the plurality of retaining structures is spaced apart from adjacent retaining structures forming an opening.

3. The apparatus for supporting an inverted container of claim 2, wherein the opening is adapted to receive a small container relative to the container and to support the small container in an inverted position.

4. The apparatus for supporting an inverted container of claim 1, further comprising a support structure disposed to the outer surface.

5. The apparatus for supporting an inverted container of claim 1, wherein the plurality of retaining structures comprise a flexible material.

6. The apparatus for supporting an inverted container of claim 1, wherein the plurality of retaining structures and the structure comprise a flexible material.

7. The apparatus for supporting an inverted container of claim 6, further comprising a support structure disposed to the outer surface.

8. The apparatus for supporting an inverted container of claim 1, wherein the structure comprises a ring shape.

9. The apparatus for supporting an inverted container of claim 1, wherein the plurality of retaining structures are configured to support a plurality of containers, the plurality of containers comprising multiple shapes and multiple sizes.

10. The apparatus for supporting an inverted container of claim 9, wherein the plurality of retaining structures are flexible and adapt to a shape and size of a particular contained of the plurality of containers thereby supporting the particular container in an inverted position.

11. The apparatus for supporting an inverted container of claim 10, wherein a larger container disposed within the structure contacts substantially all of the plurality of retaining structures and a small container relative to the larger container contacts substantially fewer of the plurality of retaining structures relative to the larger container.

12. An insert for a container basket to support containers in an inverted position, comprising:
an insert support structure comprising an inner surface and an outer surface;
a plurality of retaining structures disposed to the inner surface and extending out from the inner surface forming a center portion of the structure;
wherein the center portion is adapted to receive a top portion of a container and the plurality of retaining structures are adapted to support the container in an inverted position.

13. The insert of claim 12, wherein the plurality of retaining structures are configured to support a plurality of containers, the plurality of containers comprising multiple shapes and multiple sizes.

14. The insert of claim 12, wherein the plurality of retaining structures are flexible and adapt to a shape and size of a particular contained of the plurality of containers thereby supporting the particular container in an inverted position.

15. A shower container, comprising:
a support structure comprising an inner surface and an outer surface;
a plurality of retaining structures disposed to the inner surface and extending out from the inner surface forming a center portion of the structure;
wherein the center portion is adapted to receive a top portion of a container and the plurality of retaining structures are adapted to support the container in an inverted position.

16. The shower container of claim 15, wherein the plurality of retaining structures comprise a flexible material.

17. The shower container of claim 15, wherein the support structure comprises a rectangular shape.

18. The shower container of claim 15, wherein the support structure comprises a triangular shape.

19. The shower container of claim 15, wherein the plurality of retaining structures are configured to support a plurality of containers, the plurality of containers comprising multiple shapes and multiple sizes.

20. The shower container of claim 19, wherein the plurality of retaining structures are flexible and adapt to a shape and size of a particular contained of the plurality of containers thereby supporting the particular container in an inverted position.
